(19) United States
(12) Patent Application Publication
(10) Pub. No.: US 2011/0072712 A1
(43) Pub. Date: Mar. 31, 2011

(54) BED BUG CAPTURING DEVICE

(75) Inventors: Bruce C. Black, Yardley, PA (US); Shreya J. Shah, Lawrenceville, NJ (US); Linda A. Varanyak, Mercerville, NJ (US); Keith F. Woodruff, Mountainside, NJ (US)

(73) Assignee: FMC CORPORATION, Philadelphia, PA (US)

(21) Appl. No.: 12/872,456

(22) Filed: Aug. 31, 2010

Related U.S. Application Data
(60) Provisional application No. 61/246,315, filed on Sep. 28, 2009.

(51) Int. Cl. A01M 1/10

(52) U.S. Cl. 43/123

(57) ABSTRACT

The present invention relates to a bed bug capturing device comprising: (a) a bed bug attractant element comprising (i) a heavier than air organic chemical which attracts bed bugs; and (ii) a means for producing air flow such that the air movement from the device has a face velocity of between about 5 and about 50 ml/cm²/min; and (b) a trap element. Preferably, such means of producing air flow is a fan.

### FIELD OF THE INVENTION

The present invention relates to a bed bug capturing device.

### BACKGROUND OF THE INVENTION

Bed bugs are small nocturnal insects of the family Cimicidae that feed off the blood of humans and other warm blooded hosts. Bed bugs exhibit cryptic behavior, which makes their detection and control difficult and time consuming. This is particularly true for the common bed bug, Cimex lectularius, which has become well adapted to human environments. Other species of bed bugs are nuisances to people and/or animals as well.

While bed bugs have been controlled in many areas, such as the United States, the increase in international travel has contributed to a resurgence of these pests in recent years. There are many aspects of bed bugs which make it difficult to eradicate them once they have established a presence in a location. Accordingly, there is a need for effective traps to determine the presence of bed bugs before they become entrenched.

Adult bed bugs are about 6 millimeters long, 5 to 6 millimeters wide, and are reddish brown with oval, flattened bodies. The immature nymphs are similar in appearance to the adults, but are smaller and lighter in color. Bed bugs do not fly, but can move quickly over surfaces. Female bed bugs lay their eggs in secluded areas and can deposit up to five eggs per day, and as many as 500 during a lifetime. The bed bug eggs are very small, about the size of a dust spec. When first laid, the eggs are sticky causing them to adhere to surfaces.

Bed bugs can go for long periods of time without feeding. Nymphs can survive for weeks without feeding, while adults can survive for months. Consequently, infestations cannot be eliminated simply by leaving a location unoccupied for brief periods of time. Further, such feeding habits make it difficult to monitor whether bed bugs are present as they may only be attracted to bait when hungry. Thus, in order to be effective, a bed bug capturing device must be able to generate attractants at an effective concentration for an extended period of time.

While bed bugs are active during the nighttime, during daylight they tend to hide in tiny crevices or cracks. Bed bugs may therefore find easy hiding places in beds, bed frames, furniture, along baseboards, in carpeting and countless other places. Bed bugs tend to congregate but do not build nests like some other insects.

Bed bugs obtain their sustenance by drawing blood through elongated mouth parts. They may feed on a human for 3 to 10 minutes, although the person is not likely to feel the bite. After the bite, the victim often experiences an itchy welt or a delayed hypersensitivity reaction resulting in a swelling in the area of the bite. However, some people do not have any reaction or only a very small reaction to a bed bug bite. Bed bug bites have symptoms that are similar to other pests, such as mosquitoes and ticks. It is not possible to determine whether a bite is from a bed bug or another type of pest; and bites may be misdiagnosed as hives or a skin rash. Consequently, bed bug infestations may frequently go on for long periods before they are recognized.

Bed bug infestations originate by a bed bug being carried into a new area. Bed bugs are able to cling to possessions and hide in small spaces, such that they may be transported in a traveler's belongings. As a result, buildings where the turnover of occupants is high, such as hotels, motels, inns, barracks, cruise ships, shelters, nursing homes, camp dwellings, dormitories, condominiums and apartments, are especially vulnerable to bed bug infestations.

Because of all the features of bed bugs described herein, bed bugs are both difficult to detect and eradicate. Professional pest removal specialists and pesticides are needed. It is necessary to remove all clutter and unnecessary objects from a room, remove bed bugs and eggs as much as possible through vacuuming, and apply pesticides to likely hiding areas. This type of treatment for eradication can be disruptive to a business such as a hotel. As a result, it is desirable to detect bed bugs at the earliest possible moment before an infestation becomes established.

The tiny, mobile and secretive behavior of bed bugs makes it nearly impossible to prevent and control an infestation unless they are quickly discovered and treated. Bed bugs have been found to move through holes in walls, ceilings and floors into adjacent rooms. Devices and methods for the early detection of bed bugs are especially needed in the hospitality industries.

Many attempts have been made to devise bed bug monitoring and/or capture devices in the past. Several of these devices employ pheromones, human sweat components or other organic chemicals which are heavier than air as lures in order to attract bed bugs to their trapping mechanism.

Thus, U.S. Patent Application 2008/0168703 A1 discloses a chemical formulation which is capable of attracting bedbugs when volatized comprising a mixture of chemicals found in bed bug pheromones including a monoterpene, a saturated aldehyde, an unsaturated aldehydes and a ketone.

Somewhat similarly, U.S. Patent Application 2007/0044372 discloses components of breath, perspiration and hair or skin oil which may be employed as bed bug olfactory attractants.

However, devices employing such heavier than air organic chemical attractants have, in general, not proven to be commercially effective. The present inventors have studied many aspects of bed bug behavior, and believe that one factor in the failure of such devices to desirably perform is the failure of such devices to disperse such attractants at a rate which will be attractive to bed bugs. Thus it has been observed by the present inventors that there are optimal concentrations of such chemical attractants in terms of luring bed bugs to traps. Too low a concentration will be insufficient to attract bed bugs; conversely, at too high of a concentration, such “attractants” were found to have a repellent effect.

Because such organic chemical attractants are heavier than air, in the absence of a dispersing mechanism such chemicals will tend to remain largely within the confines of the monitoring device. Consequently, bed bugs which are located at a distance from such a monitoring device will not sense such molecules in a sufficient concentration to be attracted to the trap; bed bugs which are close to the trap may sense such chemicals at too great a concentration and may thus be repelled rather than attracted.

However, it has now been found by the present inventors that bed bugs are extremely sensitive to air movement. In this regard, it is believed that bed bugs rely on air movement to detect whether they are in an undesirably exposed location. Consequently, it has been unexpectedly observed that if such attractants are dispersed at too high a velocity, the bed bugs' sensitivity to air movement will overcome their attraction such that they are actually repelled by the device, even at otherwise attractive concentrations of these chemicals.

Accordingly, it has been unexpectedly found that, in order to be effective, bed bug monitors must ensure that the attractants are dispersed at an attractive concentration without being dispersed at too high of a velocity.

### SUMMARY OF THE INVENTION

The present invention relates to a bed bug capturing device comprising: (a) a bed bug attractant element comprising (i) a heavier than air organic chemical which attracts bed bugs; and (ii) a means for producing air flow such that the air movement from the device has a face velocity of between about 5 and about 50 ml/cm²/min; and (b) a trap element.

### DESCRIPTION OF THE DRAWINGS

FIG. 1 is a cross-sectional view of one embodiment of this invention wherein the means for producing air flow is a fan is located in the base of the device.

FIG. 2 is a cross-sectional view of a second embodiment of this invention wherein the means for producing air flow is a fan located in the cover of the device.

FIG. 3 is a graph showing experimental results obtained in Example 3.

FIG. 4 is a graph showing experimental results obtained in Example 4.

### DETAILED DESCRIPTION OF THE INVENTION

In one aspect, the present invention relates to a bed bug capturing device comprising: (a) a bed bug attractant element comprising (i) a heavier than air organic chemical which attracts bed bugs; and (ii) a means for producing air flow such that the air movement from the device has a face velocity of between about 5 and about 50 ml/cm²/min; and (b) a trap element.

The capturing device of this invention may be used as a monitoring device in order to determine whether bed bugs are present; and/or as a device for controlling bed bugs.

The device of this invention may comprise any heavier than air organic chemical bed bug attractant which is effective to lure the bed bugs into the device. Attractants which may be employed include pheromones, human sweat components and the like. Specific attractants which can be employed include bedbug pheromone components including monoterpenes (such as (+)-limonene and (−)-limonene); saturated aldehydes (such as nonanal and decanal), unsaturated aldehydes (such as (E)-2-hexenal, (E)-2-octenal, (E,E)-2,4-octadienal, and (E,Z)-2,4-octadienal), aromatic aldehydes (such as benzaldehyde), ketones (such as sulcatone and geranylacetone), acetates (such as benzyl acetate), aromatic alcohols (such as benzyl alcohol); human breath components (such as carbon dioxide, methanol, furan, and pyridine); human perspiration components (including lactic acid, butyric acid, octenol, indole, 6-methyl-5-hepten-2-one, geranyl acetone, 1-dodecanol, 3-methyl-1-butanol, carboxylic acids, and urea); and human skin oil components such as sebum. Mixtures of one or more attractants may also be employed.

Preferably, the attractant employed comprises at least one member of the group consisting of organic acids and aldehydes; and more preferably comprises at least one member of the group consisting of butyric acid, trans-2-hexen-1-al (Hexenal) and trans-2-octen-1-al (Octenal).

One particularly preferred attractant comprises an unsaturated aldehyde component and an organic acid component. It is preferred that the unsaturated aldehyde component be comprised of one or more aldehydes selected from the group consisting of Hexenal and Octenal. It is preferred that the organic acid component be butyric acid. When the aldehyde component is comprised of both Hexenal and Octenal, it is preferred that the aldehydes be present in a ratio of from about 1:5 and about 5:1 of Hexenal to Octenal, more preferably in a ratio of between about 3:1 and about 1:3. In order to be most attractive to bed bugs, the optimal concentration of the Hexenal and Octenal mixture to be released is from about 50 ng/L/hr to about 200 ng/L/hour, and the optimal concentration of butyric acid to be released is between about 15 ng/L/hr and about 50 ng/L/hr. Mixing butyric acid with Hexenal and Octenal forms an unstable composition and it is necessary to separate the aldehyde component from the acid component. In order for the separate components of the attractant composition to be released at the proper rates, each component may be dissolved in an organic solvent, for example a C₈-C₁₂ alkane. For applications in which the device may be subjected to temperature fluctuations between about 20° C. and 40° C., decane and undecane are particularly preferred solvents as their rate of volatilization is less affected by such temperature fluctuations than is nonane.

In one aspect of the invention suitable attractants comprise Octenal dissolved in decane at a concentration range of about 2000 to 3000 ppm Octenal, preferably from about 2500 to 2800 ppm octenal, and more preferably from about 2700 to 2750 ppm Octenal. A second suitable attractant that can be used in conjunction with the Octenal is butyric acid dissolved in decane at a concentration range of about 200 to 2000 ppm butyric acid, and preferably from about 240 to 400 ppm butyric acid.

Each component may be incorporated into an absorbent material, for example, but not limited to cotton batting, fiberized cellulose wood pulp, synthetic batting, polyester batting, felt, bonded carded webs, very high density polyethylene sponge and high loft spunbond materials. In order to regulate diffusion, a semi-permeable membrane can be used to encase the absorbent materials. The attractant components can be dispensed from containers with either a semi-permeable top or a sealed top containing one or more holes to allow diffusion into the surrounding atmosphere.

In one particularly preferred embodiment, the attractant is contained in an ampoule comprising: an outer shell composed of an impermeable material and defining at least one opening; a porous diffusion member defining an internal reservoir positioned inside said outer shell; a volatile liquid comprising the attractant contained within such internal reservoir; and a film member adhered to said outer shell and covering said at least one opening; wherein said film member is disposed such that an air space is present between said porous diffusion member and said film member; and wherein said porous diffusion member is configured such that molecules of the volatile liquid can only enter into said air space via diffusion through said porous diffusion member. The film member may be composed of a permeable material though which the attractant will diffuse at a desired rate; or it may be made of an impermeable material and define one or more holes of a predetermined size in order to release the attractant at a desired rate.

The attractant element of the device of this invention further comprises a means for producing an air flow such that the air movement from the device has a face velocity of between about 5 and about 50 ml/cm²/min. Preferably, such means produces an air flow such that the face velocity of air exiting the device is between about 10 and about 40 ml/cm²/min; more preferably the face velocity of air exiting the device is between about 15 and about 35 ml/cm²/min.

Any means for producing such an air flow may be employed, including compressed air, air pumps, nebulizers, heating devices, fans and the like. Preferably the means for producing air flow is a fan. Illustrative of fans which may be employed are Miniature Fan Motor Number SUNON GM0517PDD1-8 and SUNON GM0517PDV2-8.

The device of this invention additionally comprises a trap element. The trap element may comprise any means which will immobilize bed bugs such that they are unable to exit the trap once they have entered. Although sticky traps may be employed for this purpose, in general the use of such traps is not preferred in the absence of a heating element, as it has been observed that bed bugs will not be ensnared by certain adhesives which are effective to trap other insects.

Preferably, the trap element is a deadfall trap. In one particularly preferred embodiment, the trap element comprises at least one pathway comprising: (i) an upwardly sloped segment; (ii) a downwardly sloped segment having an outer portion; and (iii) a deadfall trap area: characterized in that the upwardly sloped segment and at least the outer portion of the outer portion of the downwardly sloped segment possesses an average surface roughness of at least about 2.5 micrometers, more preferably of at least about 3.0 micrometers. The average surface roughness of a material can be measured using a Pocket Surf® portable surface roughness gage available from Mahr Federal Inc.

If desired, the trap area may contain an insecticide or a viscous liquid which will further immobilize or kill bed bugs.

The device should be configured such that the air flow production means causes the attractant(s) to flow out of the device at a face velocity of between about 5 and about 50 ml/cm²/min; preferably of between about 10 and about 40 ml/cm²/min; and more preferably of between about 15 and about 35 ml/cm²/min. This can be achieved by means well known to those of skill in the art. Thus, for example, when the air flow production means is a fan, such fan can be positioned so that it blows directly onto the attractant or attractant formulation. Alternatively, assuming that the chemical attractant is sufficiently volatile, the fan may be positioned such that it blows volatilized attractant out of the device at the desired velocity.

The attractant(s) should be formulated and/or packaged such that the concentration of attractant(s) in such outflow is capable of attracting bed bugs. In the case of the Octenal/Hexenal/butyric acid attractant discussed above, this can be achieved by dissolving such materials in a C₈-C₁₂ alkane; placing such formulation into a sealed ampoule having an internal reservoir formed from a permeable diffusion member composed of ultra high molecular weight polyethylene having a pore size of less than 1 micron; and having an impermeable covering (e.g., made of aluminum sheet or tape); and providing a single 0.29 mm diameter puncture in such cover.

Moreover, the device should be configured such that the bed bugs are lured into the pathway of the trap element and induced to follow it until they are trapped in the trap area. This may be accomplished by locating the attractant within the walls of the trap area, e.g., by having the attractant pass through one or more chimneys or holes located within the radius of the trap area.

The device of this invention may be made of any suitable material or materials which do not repel bed bugs. Preferred materials include hard plastics such as high impact polyethylene or acrylonitrile butadiene styrene. Other materials which may be employed include polychlorotrifluoroethylene, polycarbonates, polyvinylidene chloride, high density polyethylene, cardboard, wax paper board, galvanized metal and aluminum.

It is preferred that the device be dark in color, for example black, dark gray, navy blue, dark blue or deep violet as bed bugs tend to choose darker surfaces over lighter surfaces. In general, colors darker than a photographic gray card are preferred.

When employing such a bed bug capturing device, care should be taken to ensure that the trap is placed flush with the surface on which it is positioned in order to avoid having the bed bugs crawl underneath instead of into the trap.

The present invention may be better understood by reference to the attached Figures which are intended to be demonstrative of certain embodiments, but are not intended to be limiting of the scope of the invention in any manner.

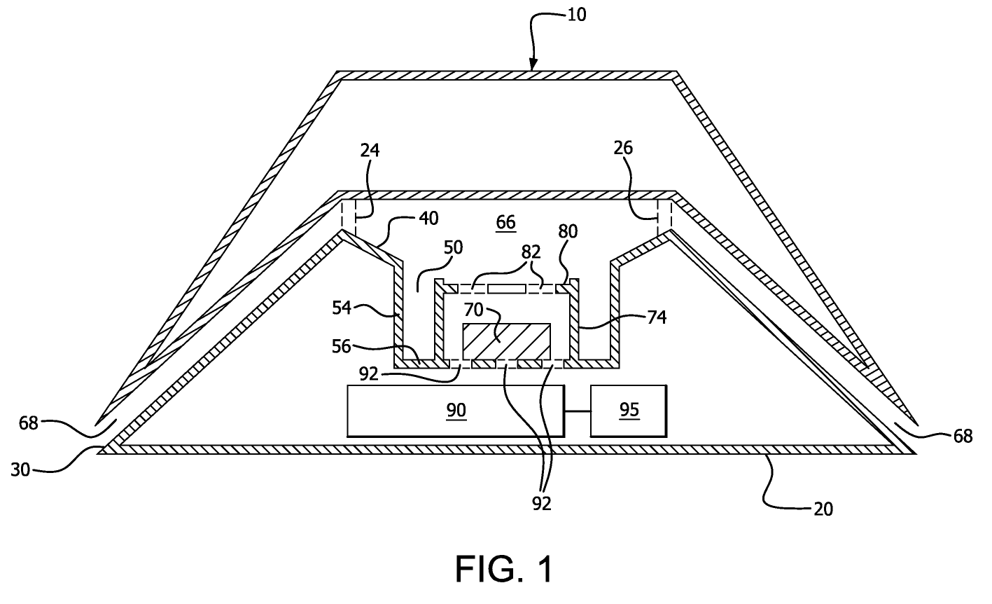

FIG. 1 is a cross-sectional view of one embodiment of this invention wherein the means for producing air flow is a fan is located in the base of the device, which device is circular in shape. This device is composed of top member 10 and bottom member 20, which are connected by rods 24 and 26. Bottom member 20 comprises a deadfall capturing element comprised of upwardly sloped segment 30, downwardly sloped segment 40, and deadfall trap area 50 which is defined by substantially vertical wall 54 and substantially horizontal base 56.

The device further comprises a bed bug attractant element comprised of attractant 70 which is placed inside a well located in the trap area formed by wall 74. Foil layer 80, containing holes 82, is stretched across and bonded to wall 74. The attractant element further comprises fan 90, which is powered by battery 95, although alternatively an external power source could be employed. Air created by the circulation of fan 90 passes through holes 92, causing molecules of attractant 70 to pass through holes 82 into central cavity 66, and out of the device through channel(s) 68. The speed of the fan and the size of the holes and channels are regulated such that the outflow of attractant from the device has a face velocity of between about 5 and about 50 ml/cm²/min.

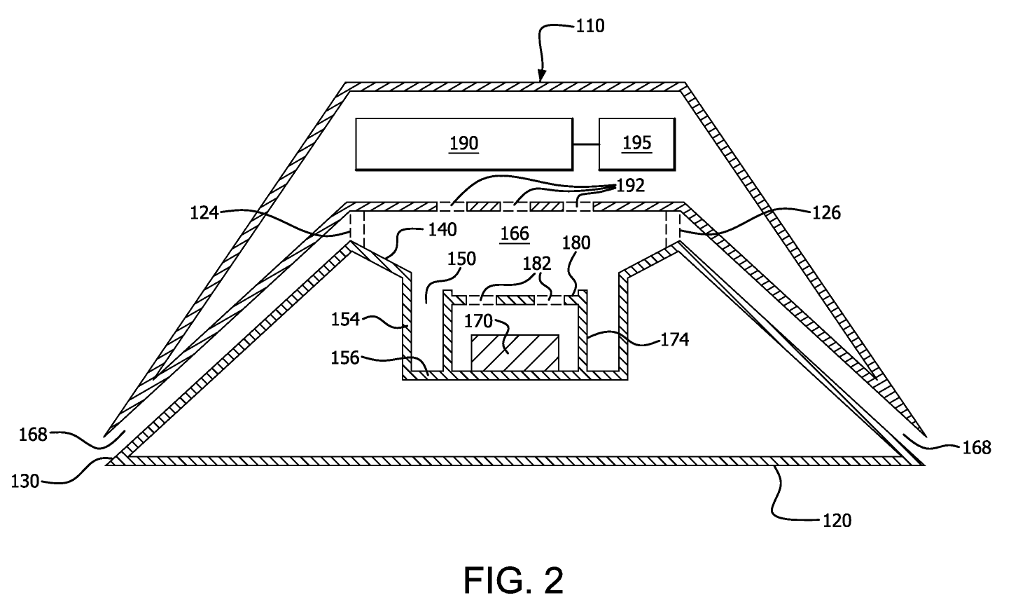

FIG. 2 is a cross-sectional view of a second embodiment of this invention wherein the means for producing air flow is a fan located in the cover of the device, which device is circular in shape. This device is composed of top member 110 and bottom member 120, which are connected by rods 124 and 126. Bottom member 120 comprises a deadfall capturing element comprised of upwardly sloped segment 130, downwardly sloped segment 140, and deadfall trap area 150 which is defined by substantially vertical wall 154 and substantially horizontal base 156.

The device further comprises a bedbug attractant element comprised of attractant 170 which is placed inside a well located in the trap area formed by wall 174. Foil layer 180, containing holes 182, is stretched across and bonded to wall 174. The attractant element further comprises fan 190, which is powered by battery 195, although alternatively an external power source could be employed. Air created by the circulation of fan 190 passes through holes 192, causing molecules of attractant 170 (which have passed through holes 182 into central cavity 166 via diffusion) of the device via channel 168. The speed of the fan and the size of the holes and channels are regulated such that the outflow of attractant from the device has a face velocity of between about 5 and about 50 ml/cm²/min.

### EXAMPLES

### Example 1

Attraction Assays: Assay arenas were made from 150×15 mm plastic Petri dishes (VWR#25384-326) containing a 125 mm piece off qualitative filter paper (VWR#28320-100) glued to the bottom using 3M Super 77® multipurpose spray adhesive. An 80 mm hole was cut into the lid and a 500 um mesh Nytex® screen (Bioquip, #7293B) was glued to cover the opening using quick epoxy. Fresh bottom dishes were used in each assay. For these experiments 2.4 cm filter paper was folded to create a tent and was treated with either a control solution (10 microliters of silicon oil) or 10 microliters of the experimental chemical diluted in silicon oil. Ten bed bugs per test were used. Day cycling bed bugs (Cimex lectularius), 12 hour light: 12 hour dark (7 AM On: 7 PM Off) light cycle, were incubated and evaluated under normal room lighting conditions at room temperature. Readings were taken at 1 hour intervals from the release of bedbugs for 4 hours. The number of bed bugs under the control filter paper disk and the number of bed bugs under the experimental filter paper disk were recorded. The test chemical was considered to be an attractant if the number of bed bugs under the experimental filter disk was greater than the number under the control filter disk. Table 1 below summarizes the experimental data, the experimental tests considered as attractants are in bold.

TABLE 1
Bed Bug Attraction to Aldehydes

| | 1 Hour | | 2 Hour | | 3 Hour | | 4 Hour | |
|---|---|---|---|---|---|---|---|---|
| Treatment Rate | Con- | | Con- | | Con- | | Con- | |
| *(ppm) | trol | Exp | trol | Exp | trol | Exp | trol | Exp |
| Hexenal | | | | | | | | |
| *10000 | 3 | 0 | 4 | 1 | 4 | 1 | 4 | 1 |
| 1000 | 1 | 6 | 1 | 7 | 1 | 9 | 1 | 9 |
| 100 | 0 | 6.5 | 0 | 8 | 0 | 9 | 0 | 8.5 |
| 10 | 9 | 3 | 5 | 3.5 | 5 | 4 | 5 | 5.5 |
| 1 | 0 | 4 | 0 | 6 | 0 | 6.5 | 0.5 | 6 |
| Octenal | | | | | | | | |
| *10000 | 0 | 2 | 2 | 2 | 3 | 2 | 4 | 4 |
| 1000 | 1.5 | 5 | 3 | 4.5 | 3 | 5 | 3 | 5 |
| 100 | 0 | 5 | 1 | 6.5 | 1 | 7 | 1 | 6.5 |
| 10 | 4 | 2 | 4.5 | 4 | 5 | 4.5 | 5.5 | 4 |
| 1 | 5 | 1 | 4.5 | 2 | 5.5 | 3.5 | 3.5 | 5 |

*10000 ppm rate for Hexenal and Octenal was one test; all others were an average of two tests.
Hexenal is trans-hex-2-en-1-al
Octenal is trans-oct-2-en-1-al

The above data indicate that bed bug attractants such as Hexenal and Octenal will be most effective at concentrations in the hundreds through thousands of ppm; and that when employed at higher concentrations such “attractants” will exhibit a repellent effect.

### Example 2

A test arena was constructed from a 60×40×22 cm (L:W:H) polystyrene container. A 60×40 cm piece of filter paper was glued on the bottom to provide a walking surface for the bedbugs. At one end of the test arena, a triangular piece of plastic (16 cm high×25 cm long) was glued to the middle of the side and bottom of the container to create a partition of equal area on either side of the partition. Deadfall insect trap bases were placed in both the control and the experimental zones.

The control trap did not contain any lure, while the test trap contained two one hundred micro Liter pipettes. One end of each pipette (Drummond Wiretrol 100 μL) was sealed with parafilm while the other end was left open. The first pipette contained a 300 ppm solution containing Hexenal and Octenal in a 75:25 weight ratio, prepared by dissolving the aldehydes in decane. The second pipette contained a 200 ppm solution of butyric acid in nonane.

Fifty bed bugs (Cimex lectularius) were entrapped within an inverted 90 mm Petri dish at a position furthest from the control and experimental zones until bed bugs were quiescent. Removal of the Petri dish started the experiment. After 2 hours it was observed that 20-30 bedbugs were located within 5-15 cm of the test trap, but that no bed bugs were closer than 5 cm to the trap. This observation supports the conclusion that these attractants will effectively attract bed bugs at a given concentration, but will repel them if present at too high a concentration.

### Example 3

A test arena was constructed from a 60×40×22 cm (L:W:H) polystyrene container. A 60×40 cm piece of filter paper was glued on the bottom to provide a walking surface for the bedbugs. At one end of the test arena, a triangular piece of plastic (16 cm high×25 cm long) was glued to the middle of the side and bottom of the container to create a partition of equal area on either side of the partition. On each side of this partition a piece of Tygon® tubing was inserted through a hole 7 cm above the bottom of the test arena to deliver a control gas to one side of the partition, being the control zone and test gas to the other side of the partition, being the experimental zone. The tubing was positioned to deliver the gases downward into the test arena with each outlet 6 cm above the uppermost rim of an uncovered deadfall trap.

Gasses having the composition described below were released in controlled amounts to both the control and the experimental zones of the test arena. To achieve this Fisher & Porter (Gottingen, West Germany) and MG Scientific gas air gages were calibrated using volume displacement. The relationship between valve settings and air flow was determined and using this information, valve settings were determined that could deliver air at predetermined flow rates. The control gas used for these experiments consisted of house compressed air. A 300 ppm solution containing Hexenal and Octenal in a 75:25 weight ratio was prepared by dissolving the aldehydes in decane. Similarly, a 200 ppm solution of butyric acid was prepared in nonane. One 100 micro liter pipette (Drummond Wiretrol 100 μL) was filled with the aldehyde solution and one 100 micro liter pipette was filled with the butyric acid solution. One end of each micro liter pipette was sealed with parafilm leaving one end of each open. The filled pipettes were affixed inside a plastic container which had an air inlet fitting on one side and an air outlet fitting on the opposite side. An air tight lid was placed onto the plastic container and the container was installed in-line after humidity and temperature conditioning of the gas and before the gas entered the arena. The micro liter pipettes were weighed before and after use to determine the amount of aldehyde and acid released.

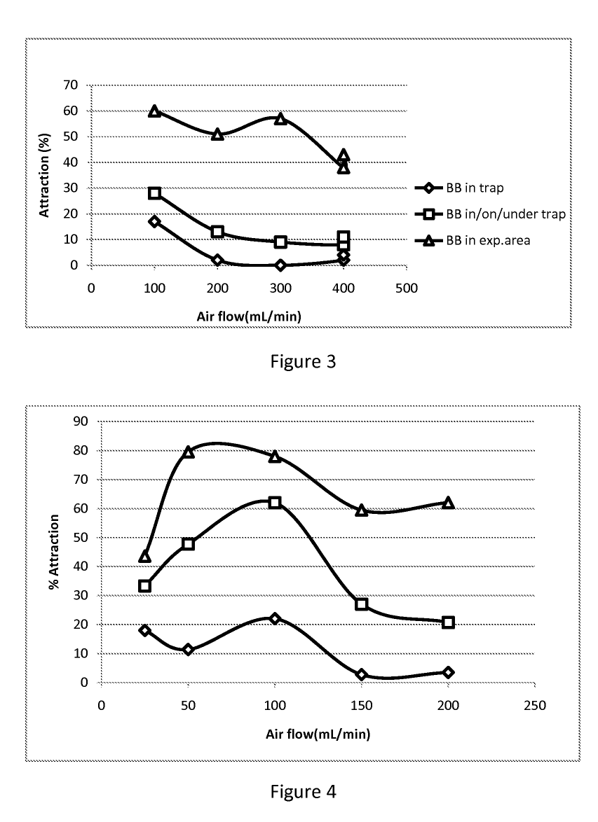

Fifty bed bugs (Cimex lectularius) were entrapped within an inverted 90 mm Petri dish at a position furthest from the control and experimental zones until the bed bugs were quiescent. Removal of the Petri dish started the experiment and readings were taken after 2 hours. Data collected were 1) number of bed bugs in the deadfall trap in the experimental zone; 2) number of bed bugs in or on the deadfall trap or under the base of the trap in the experimental zone; and 3) number of bed bugs in the experimental zone including in or on the deadfall trap or under the base. The results of such testing are shown in FIG. 3.

The results shown in FIG. 3 indicate that at air flows greater than about 200 mL/minute bed bugs are deterred from entering a monitoring device.

### Example 4

A test arena was constructed from a 60×40×22 cm (L:W:H) polystyrene container. A 60×40 cm piece of filter paper was glued on the bottom to provide a walking surface for the bedbugs. At one end of the test arena, a triangular piece of plastic (16 cm high×25 cm long) was glued to the middle of the side and bottom of the container to create a partition of equal area on either side of the partition. On each side of this partition a piece of Tygon® tubing was positioned through a cover of a deadfall insect trap to deliver compressed air downward at a predetermined velocity into a deadfall trap base which functioned as a bed bug trap area. The gap between the top and bottom of the deadfall area was 2.5 mm.

The control trap did not contain any lure, while the test trap contained two one hundred micro Liter pipettes. One end of each pipette (Drummond Wiretrol 100 μL) was sealed with parafilm while the other end was left open. The first pipette contained a 300 ppm solution containing Hexenal and Octenal in a 75:25 weight ratio, prepared by dissolving the aldehydes in decane. The second pipette contained a 200 ppm solution of butyric acid in nonane.

Fifty bed bugs (Cimex lectularius) were entrapped within an inverted 90 mm Petri dish at a position furthest from the control and experimental zones until the bed bugs were quiescent. Removal of the Petri dish started the experiment and readings were taken after 2 hours. Data collected were 1) number of bed bugs in the deadfall trap base in the experimental zone (represented by diamonds in FIG. 4); 2) number of bed bugs in or on the deadfall trap or under the base of the trap in the experimental zone (represented by squares in FIG. 4); and 3) number of bed bugs in the experimental zone including in or on the deadfall trap or under the base of the trap (represented by triangles in FIG. 4). The results of such testing are shown in FIG. 4.

In FIG. 4 (as in FIG. 3), the triangles indicate the number of bed bugs in the experimental zone; the squares indicate the number of bed bugs in, on or under the trap; and the diamonds indicate the number of bed bugs in the trap.

Given the 2.5 mm height of the deadfall trap area, it is calculated that the following air movement face velocities existed at the following air flows:

| Air Flow (mL/min) | Face Velocity (ml/cm²/min) |
|---|---|
| 25 | 5.9 |
| 50 | 11.8 |
| 100 | 23.6 |
| 150 | 35.4 |
| 200 | 47.2 |

What is claimed is:

1. A bed bug capturing device comprising: (a) a bed bug attractant element comprising (i) a heavier than air organic chemical which attracts bed bugs; and (ii) a means for producing air flow such that the air movement from the device has a face velocity of between about 5 and about 50 ml/cm²/min; and (b) a trap element.

2. The device of claim 1 wherein the means for producing air flow is a fan.

3. The device of claim 1 wherein the output of the means for producing air flow is such that the air movement from the device is between about 10 and about 40 ml/cm²/min.

4. The device of claim 1 wherein the output of the means for producing air flow is such that the air movement from the device is between about 15 and about 35 ml/cm²/min.

5. The device of claim 1 wherein such device comprises a base and a cover.

6. The device of claim 5 wherein the means for producing air flow is a fan located in the base of the device.

7. The device of claim 5 wherein the means for producing air flow is a fan located in the cover of the device.

8. The device of claim 1 wherein such trap element is a deadfall trap.

9. The device of claim 1 wherein the heavier than air organic chemical comprises an aldehyde.

10. The device of claim 9 wherein said aldehyde is selected from the group consisting of Octenal and Hexenal.

11. The device of claim 1 wherein the heavier than air organic chemical comprises butyric acid.

12. The device of claim 1 wherein the means for producing air flow is positioned such that it blows air directly on the formulation comprising the organic chemical.

13. The device of claim 1 wherein the means for producing air flow is positioned such that it blows volatilized organic chemical out of the device.
